(19) United States
(12) Patent Application Publication
(10) Pub. No.: US 2014/0082013 A1
(43) Pub. Date: Mar. 20, 2014

(54) QUERY TEMPLATES FOR QUERIES IN DATA STREAM MANAGEMENT SYSTEMS

(71) Applicant: SAP AG, Walldorf (DE)

(72) Inventors: Bernhard Wolf, Dresden (DE); Arne Schramm, Dresden (DE); Andre Preussner, Dresden (DE); Raik Hartung, Dresden (DE)

(73) Assignee: SAP AG, Walldorf (DE)

(21) Appl. No.: 13/623,682

(22) Filed: Sep. 20, 2012

(51) Int. Cl. G06F 17/30

(52) U.S. Cl. CPC G06F 17/30424
USPC 707/769

(57) ABSTRACT

A template manager may determine a query template for instantiation thereof to thereby obtain a query instance for application of the query instance against stream data of a data stream management system, the query template including placeholders. A value handler may be configured to replace the placeholders with corresponding substitution values to obtain the query instance. A query instance manager may be configured to deploy the query instance within the data stream management system for application against the stream data

### TECHNICAL FIELD

This description relates to the creation and deployment of queries in data stream management systems.

### BACKGROUND

In traditional databases and data management systems, data is stored in an essentially static form within one or more computer memories. That is, the data may generally be altered when desired, but at any given moment the stored data represents a discrete, static, finite, persistent data set against which, e.g., queries may be issued.

In many settings, however, data may not be effectively or usefully managed in this way. In particular, for example, it may occur that data arrives essentially continuously, as a stream of data points corresponding, e.g., to real world events. Data stream management systems (DSMS) have been developed to make use of such data.

For example, data representing events within a manufacturing facility may fluctuate over the course of a day and/or over the lifetime of equipment within a facility. Such data may provide insight into an operational status of the facility, and such insight may be utilized in order to optimize related operations. Additional/alternative examples of such data streams include, e.g., temperature or other environmental data collected by sensors, computer network analytics, patient health data, or data describing business processes.

During runtime, pre-stored queries may be applied against the data, as the data arrives. Such queries may be created, e.g., using specialized programming languages, i.e., query languages, which are adapted for use in data stream management systems. Such query languages may be required in order to express the queries in a manner that is suitable for use in a corresponding data stream management system, and in a manner which results in the output, e.g., in the output of a potentially continuous stream, of the desired information.

Consequently, it may be difficult for non-technical or novice users of data stream management systems to create and deploy queries in a timely, accurate, and efficient manner, particularly if there is a need for a large number of such queries. Moreover, because the queries may be lengthy and/or complex, it may be difficult and time consuming even for expert users to create and deploy such queries. Further, it may occur that some or all of the queries may be required to be updated or otherwise altered over time, so that the potentially time-consuming and error-prone processes of query creation and deployment represent an ongoing and persistent bottleneck in the use of data stream management systems.

### SUMMARY

According to one general aspect, a system may include instructions recorded on a computer-readable medium and executable by at least one processor. The system may include a template manager configured to cause the at least one processor to determine a query template for instantiation thereof to thereby obtain a query instance for application of the query instance against stream data of a data stream management system, the query template including placeholders. The system also may include a value handler configured to cause the at least one processor to replace the placeholders with corresponding substitution values to obtain the query instance, and a query instance manager configured to cause the at least one processor to deploy the query instance within the data stream management system for application against the stream data.

According to another general aspect, a computer-implemented method for executing instructions stored on a computer readable storage medium may include determining a query template for instantiation thereof to thereby obtain a query instance for application of the query instance against stream data of a data stream management system, the query template including placeholders. The method may further include replacing the placeholders with corresponding substitution values to obtain the query instance, and deploying the query instance within the data stream management system for application against the stream data.

According to another general aspect, a computer program product may be tangibly embodied on a computer-readable storage medium and may include instructions. The instructions, when executed, may be configured to determine a query template for instantiation thereof to thereby obtain a query instance for application of the query instance against stream data of a data stream management system, the query template including placeholders. The instructions, when executed, may be further configured to replace the placeholders with corresponding substitution values to obtain the query instance, and deploy the query instance within the data stream management system for application against the stream data

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system illustrating the use of query templates in data stream management systems.

FIG. 2A is an example of a query template.

FIG. 2B is an example of a query instance instantiated from the query template of FIG. 2A.

FIG. 3 is a flowchart illustrating example operations of the system of FIG. 1.

FIG. 4 is a block diagram of an entity model illustrating possible data structures and associated relationships which might be used in the system of FIG. 1.

FIG. 5 is a more specific example of the data structures and associated relationships of the example of FIG. 4.

FIG. 6 is an activity diagram illustrating example operations of the system of FIG. 1 using the data structures and relationships of FIGS. 4, 5.

### DETAILED DESCRIPTION

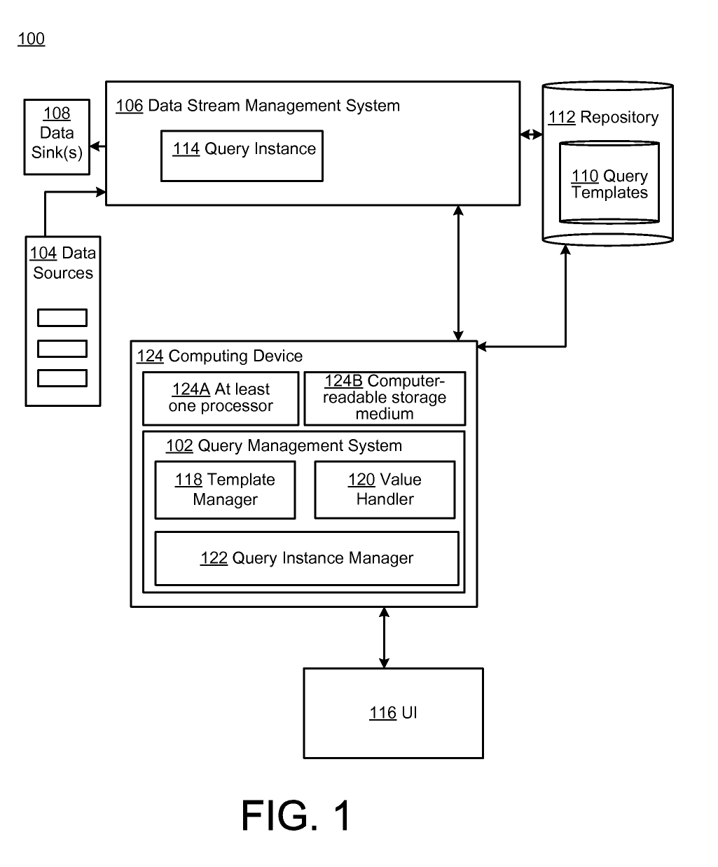

FIG. 1 is a block diagram of a system 100 illustrating the use of query templates in data stream management systems. In the example of FIG. 1, a query management system 102 operates in conjunction with data sources 104 and a data stream management system (DSMS) 106, which is itself designed to provide timely and accurate information to data sinks 108. More specifically, the query management system 102 may be configured to create and utilize query templates 110, illustrated as being stored using a repository 112, in order to instantiate and deploy query instances (illustrated by an example query instance 114) within the data stream management system 106.

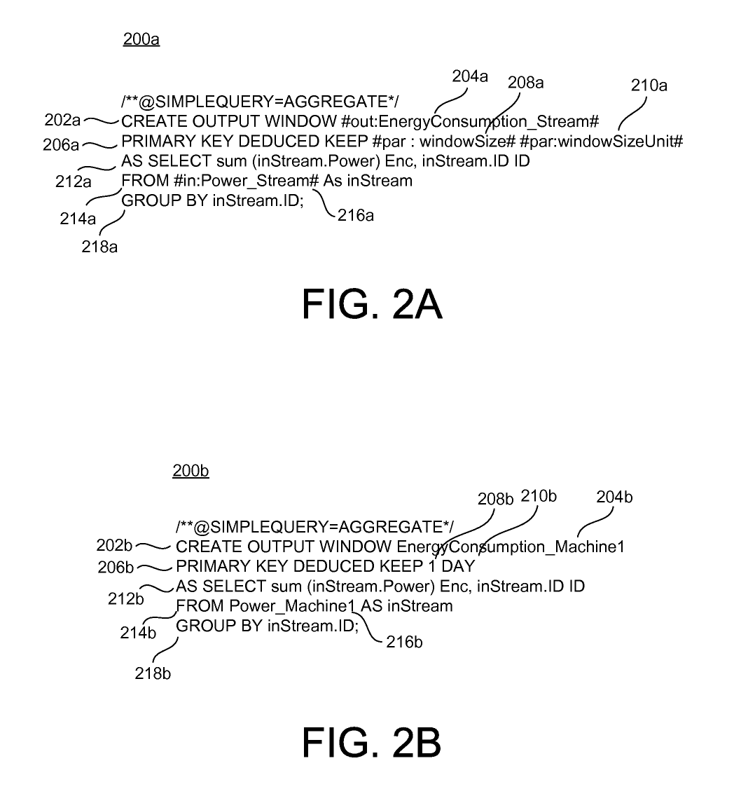

As described in more detail below, and as illustrated in the example of FIGS. 2A, 2B, the query templates 110 may be created including placeholders for alterable fields. Then, to instantiate the deployable query instance 114, the placeholders may be simply substituted with corresponding substitution values, for instance, parameter values, stream identifiers, or query operators. In this way, query instances such as the query instance 114 may be created and/or updated in a timely, efficient, and accurate manner, without requiring creation of the query instance 114 from scratch and without requiring a manual process of copying and updating an existing query instance to obtain the query instance 114.

In the example of FIG. 1, the DSMS 106 represents a modified, conventional, or substantially conventional DSMS. For example, the DSMS 106 may be implemented in a distributed manner, e.g., using various nodes communicating by network, or may be implemented in a more centralized fashion. The DSMS 106 also may represent or otherwise be referred to using other known variations/names, such as, e.g., business event processing system (BEPS), stream processing engine (SPE), or complex event processing (CEP). In any case, the DSMS 106 may be understood to represent any distributed or centralized system which receives or otherwise interacts with the stream data of the one or more stream data sources 104, where such stream data may be generally understood to represent a time series of data representing corresponding temporal events, and/or output streams resulting from operations performed using earlier such input streams.

As referenced above, such data streams are known to exist in a variety of circumstances and settings, including, for example, business, industry, healthcare, or government. To give just a few, more specific examples, the data sources 104 may output data streams representing or related to (events occurring within or with respect to) network monitoring, network traffic engineering, telecom call records, financial applications, stock market data, sensor networks, manufacturing processes, web logs and click streams, and massive data sets which are streamed as a way of handling the large volume of data. Such data streams may thus arise in enterprises, within and across government agencies, large science-related corroborations, library, or “smart” homes, to give a few examples.

Further in FIG. 1, as referenced above, the query templates 110 are illustrated as being stored within the repository 112. As described in detail herein, the query templates 110 may generally represent abstract, predefined query strings which contain one or more placeholders for corresponding alterable fields. In this way, by replacing the placeholders in a desired manner, a given query template 110 may be instantiated to obtain the corresponding query instance 114 that is deployable within the DSMS 106, as shown.

A specific example of the query templates 110 is illustrated and described below with respect to FIG. 2A, while FIG. 2B is illustrated and described with respect to a corresponding example of the query instance 114. In general, however, it may be appreciated that use of the query templates 110 provides for, e.g., automatic, efficient, and accurate generation of corresponding, deployable query instances 114. Specifically, for example, the placeholders for alterable fields may conceptually represent input streams, such as specified input streams of the data sources 104. The placeholders for alterable fields also may correspond to output streams provided to the data sinks 108, or provided as (intermediate) input streams being consumed by subsequent queries. In yet another example, the placeholders for alterable fields of the query templates 110 may correspond to parameters which characterize the query instance 114, such as, e.g., a window size or window unit to be used. Then, as referenced, to create the deployable query instance 114, the query management system 102 may substitute the various placeholders with corresponding, selected values for the input/output streams and/or parameters.

In the example of FIG. 1, a user interface (UI) 116, e.g., a graphical user interface (GUI), or one or more instances or variations thereof, may be utilized for various related purposes. For example, the UI 116 may be utilized to create a query template of the query templates 110. For example, as described in detail herein, a query template of the query templates 110 may be specified as including placeholders corresponding to certain types of input/output streams and/or certain types of parameters, and also may specify internal positions at which a value(s) for a given type of stream and/or parameter may be inserted.

In another example, the UI 116 may be utilized to select a desired query template from among the number of existing query templates 110 within the repository 112. Still further, for example, the UI 116 may be utilized to receive values from a user of the system 100 (or other appropriate source) for corresponding ones of the specified types of streams and/or parameters. In a final example, the UI 116 may be utilized to trigger, monitor, or otherwise maintain a deployment of the query instance 114 within the DSMS 106.

In the specific example of FIG. 1, the query management system 102 is illustrated as including a template manager 118. The template manager 118 may be responsible, for example, for creating the various query templates or retrieve various query templates 110 from the repository 112, perhaps based on input received from a user by way of the UI 116. The template manager 118 may be further configured to thereafter receive a selection of one or more of the query templates 110, by way of the UI 116, for subsequent instantiation and deployment thereof as the query instance 114.

Specifically, as shown, a value handler 120 may be configured to request and receive specific input/output streams and/or parameter values, or other appropriate substitution values, from a user, e.g., by way of the UI 116. In other words, subsequent to a selection of a particular query template of the query templates 110 by way of the template manager 118, the value handler 120 may thereafter receive corresponding values for the various placeholders included within the selected query template.

Thereafter, a query instance manager 122 may be configured to actually execute substitutions of values received by the value handler 120 for corresponding placeholders of the selected query template. The query instance manager 122 may execute and otherwise manage the deployment of the query instance 114 within the data stream management system 106.

Further examples and explanations of features and operations of the system 100 of FIG. 1 are provided below with respect to FIGS. 2A-6. However, it may be appreciated that such examples and explanations are non-limiting, and are merely for the sake of example and/or illustration. Consequently, many details of such implementations are not described in detail herein, to the extent that such details would be apparent to one of skill in the art. Similarly, many variations of the example implementations described herein also may be apparent to one of skill in the art.

For example, in the example of FIG. 1, the query management system 102 is illustrated as executing on a computing device 124, utilizing at least one processor 124A and computer readable storage medium 124B. In the illustrated example, the query management system 102 may execute separately, but in conjunction with, the data stream management system 106. Of course, in various examples, the DSMS 106 may execute on the same computing device 124 as the query management system 102, or on one or more separate, distributed computing devices, not specifically illustrated in the example of FIG. 1, which may be in communication with the computing device 124.

In additional or alternative example implementations, the query management system 102 may be partially or completely incorporated and, e.g., integrated, with, the DSMS 106. More generally, it may be appreciated that any single elements of FIG. 1 may be implemented using two or more sub-elements, while, conversely, two or more elements may be combined into a single element that performs all related functions.

FIG. 2A is an example 200A of a query template of the query templates 110 of FIG. 1. In the example of FIG. 2A, it is assumed that queries are required for analyzing the stream data related to one or more production facilities. For example, the system 100 of FIG. 1 may be deployed in the control and monitoring of production assets of a manufacturing plant, in order, for example, to save costs, predict down times, prevent the production of scrap, and dynamically adjust production processes. To this end, production machinery may be equipped with numerous sensors, such as vibration, power, or temperature sensors, which are designed to provide information regarding a health and production state of an associated machine.

Thus, in the example of FIG. 2A, the query template 200A may be related to calculations of energy consumption by such a machine. Therefore, a line 202a specifies creation of an output window in which a placeholder 204a is designated by hash tags, placeholder type (out:) and names a type of desired type of output stream as “EnergyConsumption_Stream.”

Somewhat similarly, a line 206a specifies related types of parameters to be used in obtaining a desired output stream. Specifically, and as shown, a placeholder 208a designates a type of parameter specifying a size of a window of data to be captured, while a placeholder 210a specifies a corresponding unit of the window size. In this context, as referenced above, the term window generally refers to discrete, defined sections or portions of received data streams obtained from data sources 104, over which, or against which, queries may be executed. Such a window thus specifies, e.g., by unit of quantity (i.e., count) and/or by unit of time, a finite set of recent events, items, or other discrete elements (also sometimes referred to as “tuples” or “data tuples”) from the otherwise-unbounded data stream.

A line 212a specifies operations to be performed on input streams in order to obtain the desired output stream. Specifically, in the example, the line 212a specifies summation of the attribute Power of the identified input stream (i.e., specified input streams having corresponding attributes) and stored as EnC (energy consumption). In the example, such input power streams to be evaluated in the line 212a are specified in a line 214a, which includes a placeholder 216a, offset by corresponding hash tags and placeholder types (in:), in identifying the relevant type of input stream.

Finally in the example query template 200A, a line 218a specifies a grouping operation that is executed with respect to individual tuple identifiers (attribute ID) in the input stream. In this regard, it may be appreciated that, although the simplified example of FIG. 2A only explicitly identifies a single placeholder for an associated input stream, it also may occur (as explained in more detail below) that a plurality of such input streams may be identified for use in the query template 200A.

Nonetheless, continuing with the simplified example of FIG. 2A, FIG. 2B illustrates an example 200B of an instantiation of the query template 200A of FIG. 2A. That is, FIG. 2B provides an example of the query instance 114 that may be obtained from a corresponding query template of the query templates 110.

Consequently, the query instance 200B includes various values which have been substituted for corresponding placeholders within the corresponding, designated alterable fields. For example, as shown, the query instance 200B includes a line 202b corresponding to the line 202a, in which the placeholder 204a has been replaced within a corresponding alterable field with a value 204b for a corresponding output stream which corresponds to an energy consumption of a particular machine which is identified as machine 1 in the example.

Similarly, a line 206b corresponds to the line 206a of FIG. 2A, in which the placeholders 208a, 210a have been replaced with corresponding alterable fields with values “1” 208b and “DAY” 210b. In other words, the line 206b specifies that the window size unit is equivalent to a 24 hour day, while the value 208b specifies that a desired value of a corresponding window is equal to 1, i.e., the resulting window is equivalent to one day's worth of data.

Similarly, a line 214b corresponds to the line 214a of FIG. 2A, and includes a value 216b substituted for the placeholder 216a within a corresponding alterable field. Specifically, as shown, the value 216b is included as identifying power measurements from machine 1 and is identified in the example as Power_Machine1. Finally in the example of FIG. 2B, it may be observed that lines 212b, 218b correspond to lines 212a, 218a of FIG. 2A. However, as observed, these lines do not contain placeholders with alterable fields, and therefore do not include any substitutions of values. Rather, the lines 212b, 218b simply specify operations to be performed by the query instance 200B according to the specified input streams and parameter values.

Of course, it may be appreciated that FIGS. 2A, 2B provide specific, simplified examples, and that many additional or alternative embodiments may be implemented. For example, instead of aggregating energy consumption over a period of time for a specific physical machine, the template 200A may be instantiated to obtain a query instance designed to provide aggregate energy consumption for a logical entity, e.g., of all machines on a particular floor, or associated with a particular group, or for an entire facility. Moreover, it may be appreciated that query templates may be formulated for the collection and/or analysis of data related to virtually any performance indicator or other metric that may be collected by the DSMS 106 by way of the data sources 104.

Further with respect to the simplified and specific examples of FIGS. 2A, 2B, it may be appreciated that the query template 200A includes the various placeholders by inserting a descriptive name (e.g., type) within corresponding hash tags, as described and illustrated above. In these examples, the placeholders may be, as shown, numbered sequentially by type. However, in other examples, such descriptive names need not be included, and, instead, query templates may include only a corresponding alterable field, designated by the hash tags of FIG. 2A or other suitable indicator serving the function of the placeholder. For example, the placeholder 204A, in such scenarios, would not require use of the indicator “out:EnergyConsumption_Stream”, and/or the placeholders may be numbered in a sequence without regard to type.

Finally with respect to the examples of FIGS. 2A, 2B, the query template 200A and the query instance 200B are illustrated using CCL (continuous computation language) which is a query language of Sybase ESP. However, it may be appreciated that many different types of stream query languages exist and may be utilized. For example, additional or alternative languages may be used including the language LINQ utilized, e.g., in Microsoft StreamInsight, and/or SQL (standard query language). In general, the concepts described herein may be utilized in a manner that is generally independent of an associated query language that is used, since language-specific elements may simply be included within a desired query template to be created and utilized.

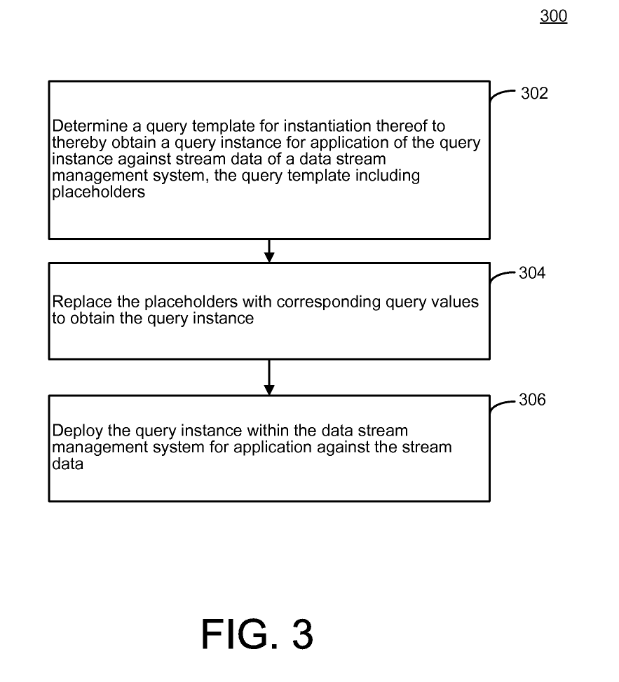

FIG. 3 is a flowchart 300 illustrating example operations of the system 100 of FIG. 1. In the example of FIG. 3, operations 302-306 are illustrated as separate, sequential operations. However, it may be appreciated that, in additional or alternative embodiments, two or more of the operations 302-306 may be executed in a partially or completely overlapping or parallel manner. Further, it may be appreciated that various additional or alternative operations may be included, that one or more such operations may be omitted in a particular embodiment, and that the various operations may be performed in a nested, iterative, or looped manner.

In the example of FIG. 3, a query template may be determined for instantiation thereof to thereby obtain a query instance for application of the query instance against stream data of a data stream management system, the query template including placeholders (302). For example, the template manager 118 may be utilized to create or select one of the query templates 110, e.g., the query template 200A. For example, in scenarios in which a relatively large number of the query templates 110 have been previously created and stored within the repository 112, the UI 116 may be utilized by a user of the system 100 to search for, identify, and ultimately select one or more desired query templates. For example, such a user might enter search terms related to aggregations of energy consumption in order to identify the query template 200A from among the query templates 110, or may search by machine, type of machine, and/or type of measurement in order to determine associated query templates, or may filter for query templates known to be applicable with respect to already-selected input streams.

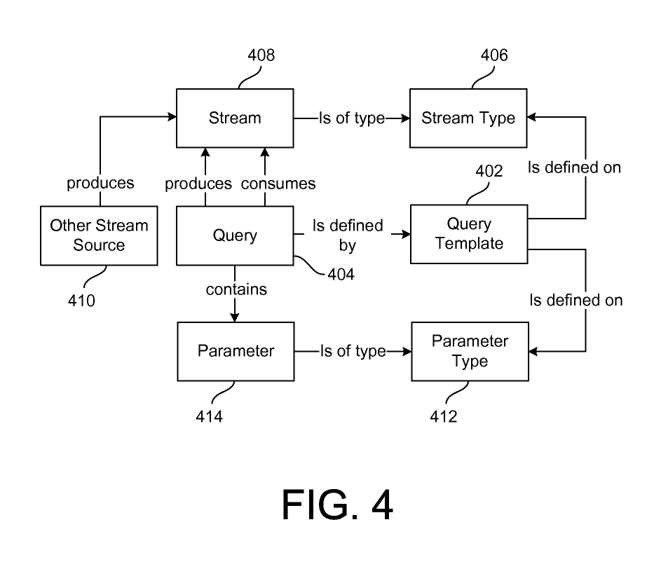

As shown and described above, such query templates may include placeholders, such as the various placeholders described with respect to FIG. 2A. In some example implementations, some of which are described below with respect to FIGS. 4-6, the placeholders may be linked or otherwise connected to various, predefined types of input/output streams and/or parameters. In such scenarios, various appropriate data structures may be utilized in order to maintain and utilize such relationships. In other examples, however, it may occur that the various placeholders simply store a particular input/output stream and/or parameter, which would then generally provide fewer potential variations of query instances that may be created using the query template, but with the benefit of simplified techniques for maintaining relationships between the query template and potential values thereof.

The placeholders may be replaced with corresponding substitution values to obtain the query instance (304). For example, the value handler 120 may request values based on metadata stored in the repository 112. In other examples, the value handler 120 of FIG. 1 may be configured to parse a selected query template, and thereby identify any and all placeholders included therein. Thereupon, the value handler 120 may request input of corresponding values for each detected placeholder, e.g., by way of the UI 116. By way of specific example, the value handler 120 may parse the query template 200A and detect, among other placeholders, the placeholders 208a, 210a. Then, the value handler 120 may request, by way of the UI 116, desired substitution values to be input by the user of the system 100 (i.e., the values 208b, 210b of FIG. 2B). In this way, once all placeholders have been substituted with corresponding, appropriate substitution values, the query instance 200B representing the query instance 114 of FIG. 1 may be obtained.

In the context of the operation 304, it may be appreciated that the term “substitution value” may generally be understood to represent virtually any value that may be included within a query to be applied against a data stream. In the specific examples described herein, such substitution values may include input streams, output streams, or any parameter which might characterize the input/output streams or other aspects of the query in question. Specific examples of such substitution values are provided in more detail below, with respect to FIGS. 4-6.

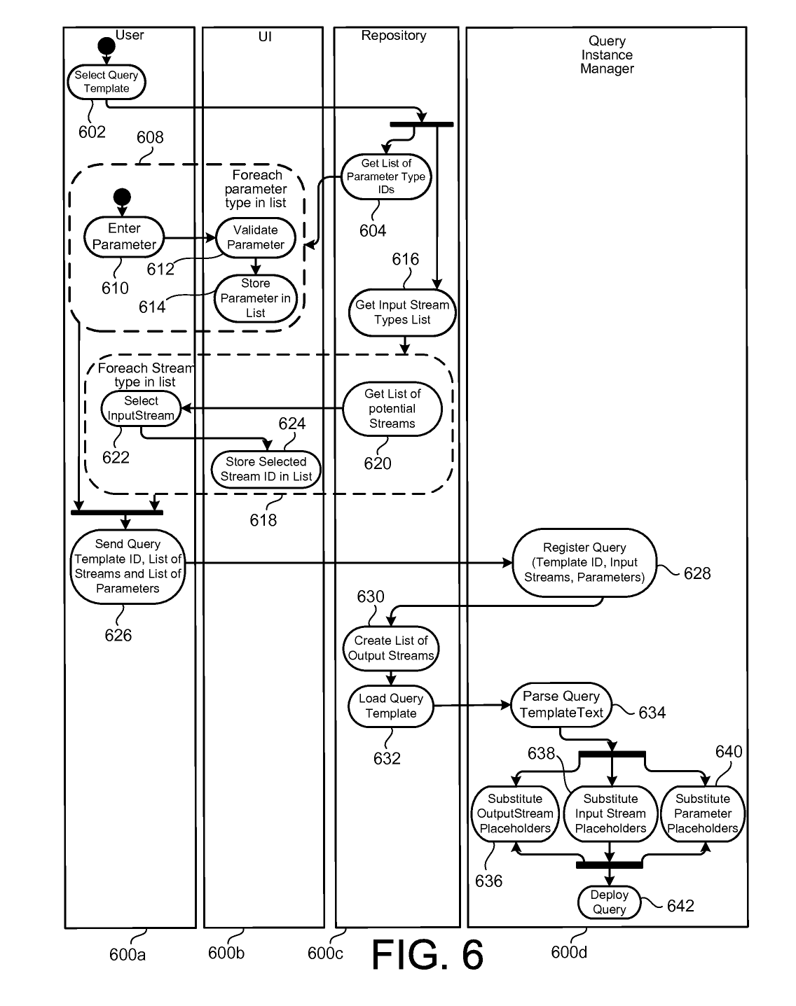

The query instance may be deployed within the data stream management system for application against the stream data (306). For example, the query instance manager 122 may be configured to deploy the query instance 114 (e.g., the query instance 200B) within the DSMS 106, for application against the data sources 104. Additional example operations of the query instance manager 122 in deploying the query instance 114 are provided below, e.g., with respect to FIG. 6.

FIG. 4 is a block diagram of an entity model that may be used in example implementations of the system 100 of FIG. 1. In the example of FIG. 4, a query template 402, representing the query templates 110 of FIG. 1 and/or the query template 200A of FIG. 2, as described, represents an abstract, predefined query containing a placeholder for each of a plurality of alterable fields contained therein. In this way, as also described above, a query 404, corresponding to the query instance 114 of FIG. 1 and/or the query instance 200B of FIG. 2B, may be defined by (e.g., instantiated from) the query template 402.

The query template 402 may be related to, e.g., defined on, one or more of a plurality of stream types 406. That is, relations between the query template 402 and compatible stream types 406 may be associated with the query template 402. For example, such a stream type may be considered to include an abstract description or characteristic of one or more streams consumed or produced by an instantiated query. For example, the stream type 406 may contain a schema of relevant stream data and other related information.

Similarly, the query template 402 may include relations between the query template 402 and compatible parameter types 412. Such a parameter type may represent an abstract description of a particular parameter. For example, the parameter type 412 may contain a data type or a schema of the relevant parameter and other related information.

Thus, each instance of a stream 408 may be associated with a corresponding stream type 406, while the parameter 414 may be associated with a corresponding parameter type 412. Thus, it may be appreciated from the above discussion, e.g., the discussion of FIG. 3, that values of the stream 408 and the parameter 414 may represent substitution values which are used to parameterize or otherwise characterize the instance of the query 404. Consequently, it may be appreciated that the query 404 contains each of the parameter values 414, as received, e.g., from a user, and consumes at least one input stream of the streams 408, while producing at least one output stream of the streams 408.

In practice, the types of streams that may be included within the stream type 406 are virtually limitless, and may be characterized by user preference or other criteria in any given stream data context. For example, in the context of production facilities, the stream types may include characterizations of the types of measurements received from various sensors (e.g., vibration, temperature, or light sensors). As in the example of FIG. 2, the stream type 406 may be characterized as a power stream representing an amount of power used by a particular machine or type of machine or group of machines. Thus, streams may be typed according to characteristics of data contained therein. In other examples, streams may be typed according to desired uses of the stream data, on geographical locations of production of the stream data, a desired business classification of the stream data, or on virtually any classification or description which is useful in providing a layer of abstraction to available data streams, so as to thereby provide a sufficiently high degree of choice while at the same time facilitating fast, efficient, and accurate identification and selection of actual input/output stream values by the user during operations of the system 100 of FIG. 1.

In practice, particular streams may be generated by, and received from, data sources such as the data sources 104 of FIG. 1, represented by stream sources 410 of FIG. 4. In additional or alternative implementations, the stream data may be generated by simulations. In other examples, stream data may be generated by previously executed queries, i.e., may include outputs of such previously-executed queries expressed as a stream of data.

The parameter 414 may be understood to represent virtually any parameter which might characterize a query to be applied against stream data. In the examples above, such parameters are related to characterizations of windows of data to be considered as well as specific characteristics of such windows. Of course, such parameters may also characterize any operator or other aspect of the query 404, including, e.g., mathematical operators, characterizations of a timing or extent of calculations to be performed, a quantity of most-recent stream data to be temporarily stored in a buffer for calculations performed thereon, conditions for beginning, modifying, or ending one or more calculations, and virtually any other parameter that may be used in conjunction with applications of queries against stream data.

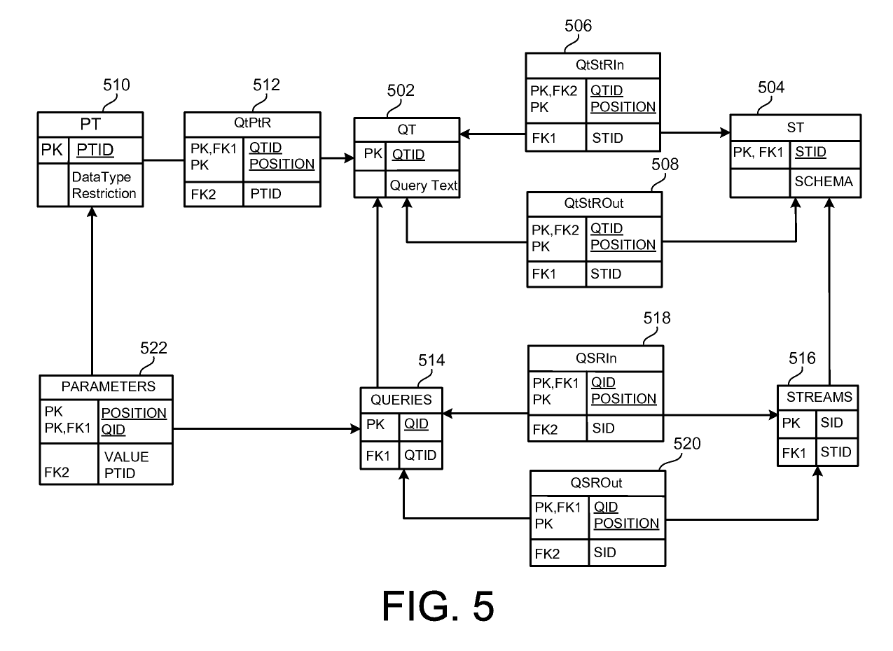

FIG. 5 is a block diagram of a data structure corresponding to the entities of FIG. 4, and utilized to store corresponding information in a table-base format. Of course, FIG. 5 may be understood to represent merely a specific example of the entity model of FIG. 4, which is itself a particular implementation of the system 100 of FIG. 1. Many additional or alternative techniques may be utilized to store and access relevant information in a desired manner. For example, the data stored using tables in FIG. 5 may alternatively be stored in the context of corresponding XML files.

In the example of FIG. 5, a table QT 502 stores a list of query templates in accordance with corresponding individual query template IDs (QTIDs). The table QT 502 contains the relevant query template representation, e.g., a query string represented as “query text” in the table QT 502. The table QT 502 also may include various other descriptive information associated with each query template, such as, e.g., a name, description, or other characteristic thereof.

Further in FIG. 5, a table ST 504 is utilized to store a list of stream types with corresponding stream type IDs (STID). The table ST 504 also may contain a schema of an associated stream type, i.e., possible attributes of the stream values, as well as other descriptive information of the corresponding stream type, such as, for example, a name, description, or other characteristic thereof.

Then, a table QtStRIn 506 may be utilized to store relations between query templates and stream types of input streams providing corresponding placeholder positions within the relevant query template. In other words, the table QtStRIn 506 may be utilized to store an existence and position of each placeholder for each query template. For example, referring back to the query template 200A of FIG. 2A, the placeholder 216a may be understood to be included at a first placeholder position thereof, and to include the stream type of “in:Power_Stream,” representing a particular type of input stream containing power values of the specified type/characteristic. Thus, in the context of the table 506, it may be appreciated that a column QTID identifies a particular query template ID of the table 502, while the POSITION refers to a column identifying a corresponding placeholder position to be associated with a particular stream type ID (STID) of a corresponding stream type of the table 504.

In a completely analogous way, a table QtStROut 508 relates placeholder positions of a particular query template with corresponding output stream type IDs (STID). For example, the placeholder 204a of the query template 200A may be observed to be at a first placeholder position of the “output streams” type of the query template 200A, and to be related to a stream type ID of a corresponding output stream identified as “out:EnergyConsumption_Stream” designed to provide a specified output stream of energy consumption values. Thus, the table 508 provides a table of relations between query templates and stream types of output streams, thereby providing the placeholder position of such stream types within a corresponding query template.

Similarly, a table PT 510 may store a list of parameter types with parameter type ID (PTID). The table 510 also may contain a type definition of the parameter, e.g., a data type or valid interval, and/or any other descriptive information related to the parameter. For example, such descriptive information may include, e.g., a name, description, unit, or other characteristic thereof.

Then, a table QtPtR 512 may represent a table of relations between query templates and parameter types providing the placeholder position of each parameter type within a query template. Thus, the table 512 operates in an analogous way to the tables 506, 508. For example, the table 512 may, for the query template 200A of FIG. 2A, store the window size unit parameter type within the placeholder 208a which occurs at a second placeholder position of the query template 200A. In other words, the placeholder 208a may be understood to be included in a first placeholder position of the “parameter” type, while the placeholder 210a may be understood to be included in a second placeholder position of the “parameter” type.

Thus, it may be appreciated that the table 502-512 generally correspond to entity models 402, 406, and 412, and relationships therebetween, of FIG. 4. Thus, similarly, tables 514-522 of FIG. 5 may be understood to provide specific examples of corresponding entities 404, 408, 414 of FIG. 4, and may be understood to be constructed in a substantially similar manner as that just described with respect to the tables 502-512.

Specifically, as shown, a table QUERIES 514 may be understood to represent a list of deployed query instances, which may be related to corresponding query templates by virtue of the appropriate query template ID QTID. Then, a table STREAMS 516 represents a list of all streams available in the system. Each stream may be stored with a reference to its corresponding stream type, identified by stream type ID STID of the table ST 504.

Then, tables 518, 520 may be understood analogously to tables 506, 508, respectively. Specifically, the table QSRIn 518 may be understood to represent a list of input streams assigned to each deployed query, including a position of each such stream within the query. As shown, each stream, identified by the stream identifier SID may be identified as existing at a particular position with any corresponding query, which is itself represented by an appropriate query ID QID (where, as shown, the query ID QID is also used to relate each query to its corresponding query template within the table 514).

Similarly, the table QSROut 520 represents a list of output streams assigned to deployed queries, also including a position of each output stream within its corresponding query. Again, each such stream is related by a corresponding stream identifier SID with its corresponding query and associated query identifier QID.

Finally in the example of FIG. 5, a table PARAMETERS 522 may be utilized to store a list of parameter values assigned to corresponding, deployed queries. Again, each such parameter value may be associated with its corresponding parameter type identifier PTID, and may be related to an appropriate position within the corresponding query QID of the table 514.

In the table-based example of FIG. 5, a series of primary keys (PK) are utilized as foreign keys (e.g., FK1, FK2) of related tables. For example, the query template ID QTID of table 502 is representing a primary key PK for the relations tables 506, 508, and also may be used as the foreign key FK1 from the perspective of the relations table 506, 508, as shown. In general, the use of such key-based relationships between tables, by itself, is known, and therefore is not described here in further detail. Moreover, it may be appreciated that various other techniques may be used for relating the various tables to one another, or, more generally, may be used for ensuring and relating information related to a desired operation of the system 100 of FIG. 1.

FIG. 6 is an activity diagram illustrating example operations of the system 100 of FIG. 1, using the data structure of FIG. 5. In the example of FIG. 6, the illustrated activity diagram demonstrates an example of a conversion of a query template into a deployable query. In the example, as shown, a user 600a interacts with a UI 600b (e.g., the UI 116 of FIG. 1), to thereby access or otherwise interact with data stored in a repository 600c (e.g., the repository 112 of FIG. 1). In this regard, with reference to FIG. 1, it will be appreciated that many of the functions and operations described in the activity diagram of FIG. 6 with respect to the user 600a and the UI 600b may occur in conjunction with the template manager 118 and/or the value handler 120. Further in FIG. 6, a query instance manager 600d, analogous to the query instance manager 122 of FIG. 1, may interact with the user 600a and the repository 600c to finalize creation and deployment of a query instance.

In the example of FIG. 6, it is assumed that a plurality of query templates, such as the query templates 110, have previously been created and stored. Thus, the user 600a may proceed to select a desired query template from the stored query templates (602).

Then, a sorted list of parameter type IDs (i.e., sorted by placeholder position) may be created from the table QtPtR 512 for the selected query template, using the corresponding query template ID QTID (604). Then, looped operations for each parameter type in the sorted list may be executed (608), until parameter values for all placeholders have been specified. Specifically, as shown, parameter values may be received from the user (610), whereupon validation of the received parameter values may be performed (612). For example, specific parameter type values may have certain requirements with respect to a data type or interval, or other characteristic, of the received value. Finally, the validated parameter value may be stored in a temporary, sorted list of parameters (614). As referenced above, these operations 610-614 may be performed in a loop (608) until validated parameter values for all placeholders have been specified.

Similarly, a sorted list of stream type IDs (i.e., sorted by placeholder position) may be created from the table QtStRIn 506 for the selected query template as specified by the corresponding query template ID QTID (616). Then, as with looped operations 608, looped operation 618 may be executed for each stream type ID in the sorted list, until all stream type values for all placeholder positions have been specified.

Specifically, as shown, a list of compatible input streams may be obtained from the table STREAMS 516 (620), while streams with the corresponding stream type ID STID may be selected. As shown, the user 600a may then select a desired stream from the list of potential streams (622), so that a corresponding stream ID may be added to a temporary, sorted list of streams (624).

Subsequently, a user 600a may initiate the action of sending the corresponding query template ID, the sorted list of parameter values, and the sorted list of input streams to the query instance manager 600d (626). Thereupon, the query instance manager may proceed to register the new query to be deployed, including registration of each of the received template ID, list of input streams, and list of parameters (628). Specifically, with reference to FIG. 5, the new query may be added to the table QUERIES 514, including the corresponding query ID QID and query template ID QTID. The list of input streams may be added to the table QSRIn 518, including the query ID QID, the stream ID SID, and the corresponding placeholder position. Similarly, the selected parameter values may be added to the table PARAMETERS 522, including the query ID QID, the parameter value, and the corresponding placeholder positions.

Then, a list of corresponding output streams may be created for storage within the repository 600c (630), based on information stored in the table QtStROut 508, looked up by query template ID QTID. Specifically, for each entry, looped operations may be performed in which a given output stream is created in the table STREAMS 516 (including a corresponding stream ID SID and stream type ID STID). Subsequently, the created output stream and its position (as obtained from the table QtStROut 508) may be added into the table QSROut 520, using the corresponding query ID QID, stream ID SID, and placeholder position. Then, the created stream ID for the output stream may be added to a temporary sorted list, (i.e., sorted by placeholder position) of output streams.

Then, the selected query template may be loaded from the table QT 502 (632). The query template text may be parsed for placeholders by the query instance manager 600D (634). Specifically, as shown, each placeholder operations 636, 638, 640 may be executed. Specifically, as shown, for each output stream placeholder (e.g., #out: . . . #), the output stream placeholder may be substituted with a current value from the sorted list of output streams (636). Specifically, the corresponding stream ID may be inserted into the query at the appropriate placeholder position.

Similarly, for each input stream placeholder (e.g., #in: . . . #), the placeholder may be substituted with a current value from the sorted list of input streams (638). That is, the corresponding stream ID for the input stream may be inserted into the corresponding placeholder position within the query instance.

Finally, and similarly, for each parameter placeholder (e.g., #par: . . . #), the placeholder may be substituted with a current value from the sorted list of parameters (640). That is, again, the corresponding parameter value may be inserted into the appropriate placeholder position within the query instance.

In this way, as shown, the finalized query instance may be deployed (642). For example, the query instance may be scheduled for execution within the DSMS 106 of FIG. 1.

As referenced above, in a simplified, alternative implementation, stream types and parameter types may be directly parsed out of a selected query template. In such scenarios, query templates may contain distinct placeholders defining the stream type or the parameter type, in which case the various tables used to store relations between query templates and stream/parameter types (e.g., tables 506, 508, 512) are not necessary. This concept may be implemented for query relations to streams and parameter values, in which case the tables 518, 520, and 522 may be unnecessary. In such implementations, parsing of the query template may be performed initially, and one or more operations of FIG. 6 may be omitted. In still other additional or alternative implementations, tables with position indices may be used in place of the various sorted lists referenced above.

Thus, it may be understood that the structures and operations of FIGS. 1-6 may be utilized to provide for flexibility and consistency in the generation of query instances for deployment within a data stream management system. Thus, for example, multiple queries can be created from a single query template quickly and easily. For instance, in a production environment, a query may be used to calculate the energy consumption from a machine's power signal. In the scenario in which a particular factory has, e.g., 100 machines, it is not necessary to create the same query 100 times with different input and output streams, or to attempt to copy an existing query and perform manual replacement of input/output streams and parameter values. Instead, use of a query template as described herein requires merely a one time effort for creating the query template with its included placeholders, which should take approximately the same time as creating a single query in conventional scenarios. The various query instances may then be created, perhaps automatically, utilizing the power streams of the specified machines, or with minimal effort by performing a stream assignment by hand via an appropriate user interface.

Further, it is possible to reuse output streams of existing queries as input streams of new queries, since queries and streams are registered automatically while being instantiated. Further, features and functions described herein are applicable to virtually any query language, and thereby provide for fast, efficient, straightforward, and accurate creation and use of queries in the context of data stream management systems.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system including instructions recorded on a computer-readable medium and executable by at least one processor, the system comprising:
a template manager configured to cause the at least one processor to determine a query template for instantiation thereof to thereby obtain a query instance for application of the query instance against stream data of a data stream management system, the query template including placeholders;
a value handler configured to cause the at least one processor to replace the placeholders with corresponding substitution values to obtain the query instance; and
a query instance manager configured to cause the at least one processor to deploy the query instance within the data stream management system for application against the stream data.

2. The system of claim 1, wherein the placeholders are included at designated alterable fields of the query template.

3. The system of claim 1, wherein the template manager is configured to construct the query template including receiving user-designated, placeholder positions of the placeholders within the query template.

4. The system of claim 1, wherein the template manager is configured to identify the query template in response to a request from a user, from among a plurality of pre-stored query templates.

5. The system of claim 1, wherein the template manager is configured to relate a placeholder position for each of the placeholders within the query template to a type of substitution value associated therewith.

6. The system of claim 1, wherein the value handler is configured to determine an associated type of substitution value for each of the placeholders, and further configured to request and receive the corresponding substitution values of each placeholder from a user.

7. The system of claim 1, wherein the substitution values include input streams of data to be processed by the data stream management system, and/or output streams of data to be produced by the data stream management system.

8. The system of claim 1, wherein the substitution values include parameters characterizing operations to be executed by the data stream management system during the application of the query instance.

9. The system of claim 1, wherein the query instance manager is configured to receive the query template and associated substitution values from the template manager and the value handler, wherein each substitution value is associated with a position of a corresponding placeholder of the placeholders.

10. A computer-implemented method for executing instructions stored on a computer readable storage medium, the method comprising:
determining a query template for instantiation thereof to thereby obtain a query instance for application of the query instance against stream data of a data stream management system, the query template including placeholders;
replacing the placeholders with corresponding substitution values to obtain the query instance; and
deploying the query instance within the data stream management system for application against the stream data.

11. The method of claim 10, wherein a placeholder position for each of the placeholders within the query template is related to a type of substitution value associated therewith.

12. The method of claim 10, wherein replacing the placeholders comprises:
determining an associated type of substitution value for each of the placeholders; and
requesting and receiving the corresponding substitution values of each placeholder from a user.

13. The method of claim 10, wherein the substitution values include input streams of data to be processed by the data stream management system, and/or output streams of data to be produced by the data stream management system.

14. The method of claim 10, wherein the substitution values include parameters characterizing operations to be executed by the data stream management system during the application of the query instance.

15. A computer program product, the computer program product being tangibly embodied on a computer-readable storage medium and comprising instructions that, when executed, are configured to:
determine a query template for instantiation thereof to thereby obtain a query instance for application of the query instance against stream data of a data stream management system, the query template including placeholders;
replace the placeholders with corresponding substitution values to obtain the query instance; and
deploy the query instance within the data stream management system for application against the stream data.

16. The computer program product of claim 15, wherein the instructions, in being configured to determine the query template for instantiation thereof, are further configured to identify the query template in response to a request from a user, from among a plurality of pre-stored query templates.

17. The computer program product of claim 15, wherein the instructions, in being configured to replace the placeholders with corresponding substitution values, are further configured to determine an associated type of substitution value for each of the placeholders, and further configured to request and receive the corresponding substitution values of each placeholder from a user.

18. The computer program product of claim 15, wherein the query substitution values include input streams of data to be processed by the data stream management system, and/or output streams of data to be produced by the data stream management system.

19. The computer program product of claim 15, wherein the substitution values include parameters characterizing operations to be executed by the data stream management system during the application of the query instance.

20. The computer program product of claim 15, wherein each substitution value is associated with a position within the query template of a corresponding placeholder of the placeholders.
